(19) United States
(12) Patent Application Publication
(10) Pub. No.: US 2026/0010819 A1
(43) Pub. Date: Jan. 8, 2026

(54) SYSTEM AND METHOD FOR AUTOMATED MACHINE LEARNING SUPPORT IN AN ELECTRONIC WARFARE ENVIRONMENT

(71) Applicant: Raytheon Company, Tewksbury, MA (US)

(72) Inventors: Andrew W. Tudor, LOS ANGELES, CA (US); Andres Ivan Vila Casado, Culver City, CA (US); Esteban Luis Valles, Los Angeles, CA (US); Hannah McDonald, El Segundo, CA (US); Garry S. Oh, SANTA BARBARA, CA (US)

(21) Appl. No.: 18/762,057

(22) Filed: Jul. 2, 2024

(51) Int. Cl. G06N 20/00

(52) U.S. Cl. CPC G06N 20/00

(57) ABSTRACT

A system and method are described for updating Machine Learning (ML) models in an electronic warfare (EW) environment. The ML models are updated automatically post mission using threat data of emitters in the EW environment and then deployed to hardware in an aircraft. The updated ML models are used during a subsequent mission and include an unsupervised ML model to deinterleave waveforms received from the emitters and a supervised ML model for emitter identification, waveform tracking, and anomaly detection based on the deinterleaved waveforms. The ML models are updated by augmenting templates that indicate the behavior of the emitters and training the ML models using many plausible superpositions of the augmented templates. The ML models are updated by selecting and applying non-linear augmentations of at least one of the templates and new templates randomly using a Monte Carlo approach.

### TECHNICAL FIELD

The present subject matter relates generally to electronic warfare (EW) systems and more specifically to methods and systems for identification, tracking, and anomaly detection of emitters in complex EW environments.

### BACKGROUND

EW involves the strategic use of the electromagnetic spectrum to detect, deceive, and disrupt enemy radar and communication systems while ensuring friendly use. In modern warfare, accurate determination whether to respond to electronic signals, particularly radar emissions, in EW environments is particularly challenging. One challenge for a system in an EW environment is the effective identification and tracking of radar emitters, which is used for assessing threats and deploying appropriate countermeasures. Data analysis and augmentation leading to deployment of logical adjustments in EW algorithms are often performed post-sortie and use significant human interaction and judgment. Human driven logical adjustments may be slow to counter advanced threat capability while being logically inefficient and costly to deploy. Moreover, such a technique does not lend itself well to determining countermeasures to advanced EW environments whose threat waveform agility may be substantial.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 illustrates an electronic warfare environment according to some embodiments.

FIG. 2 illustrates a block diagram of an electronic device in accordance with some aspects.

FIG. 3 illustrates an electronic warfare system according to some embodiments.

FIG. 4 illustrates a Dynamic Emitter Library (DEL) information pipeline according to some embodiments.

FIG. 5 illustrates a continuous learning diagram according to some embodiments.

FIG. 6 illustrates a data augmentation in (Frequency, Pulse Width) space according to some embodiments.

FIG. 7 illustrates a method of updating a machine learning model in accordance with some aspects.

### DETAILED DESCRIPTION

As above, EW systems use algorithms that are often updated after completion of a mission using data captured during the mission. Data augmentation and adjustment of the algorithm may be problematic due to limited time and human or electronic resources used to analyze a potentially massive amount of data. Accordingly, an automated and data driven strategy is provided herein to quickly manage large amounts of data while also extracting as much useful information as possible. The ability to rapidly deploy updated logic may be a significant discriminator in next generation EW environments.

The system to be updated is capable of learning from incoming data to identify and track both known and previously unknown (i.e., unseen) radar emitters. The system employs an architecture that integrates Machine Learning (ML) algorithms to dynamically classify and track radar emitters without relying solely on traditional Mission Data Files (MDFs). This approach not only enhances the adaptability of the system to new threats but also improves the ability of the system to handle emitter agility and reduce dependency on extensive pre-existing databases. The system described utilizes a combination of supervised and unsupervised ML algorithms to analyze pulse descriptor words (PDWs). This analysis enables the system to identify patterns and changes in emitter behavior that may not be documented in any database. This capability improves maintaining situational awareness and ensures that EW assets are accurately targeted and effective, thereby enhancing overall mission success in modern combat environments. The system includes Radio Frequency (RF) antennas and receivers configured to receive RF signals from an environment to model various aspects of the received analog signals. The system is configured to detect and analyze pulses within received RF signals. The analysis is used to obtain pulse parameters used to identify emitters, such as time of arrival, angle of arrival, center frequency, modulation, pulse width, receive amplitude. The system can be used in a wide variety of applications such as military, security, weather detection and forecasting, traffic enforcement, exploration, mapping, to identify the source of the pulses and determine what actions to take. In particular, a set of PDWs is determined from a digitized RF signal. The PDWs are supplied to signal processing blocks that process the pulse parameters to identify an emitter that is the most likely source of the PDWs. A library of known emitters is then updated and decision rules for future PDWs are adapted.

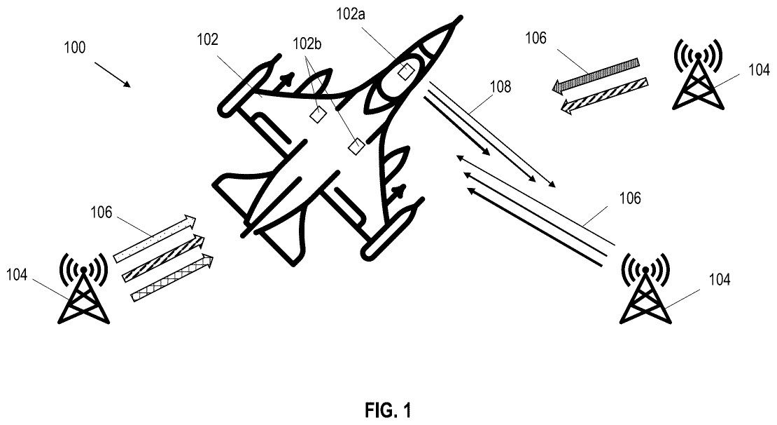

FIG. 1 illustrates an electronic warfare environment according to some embodiments. As shown, an aircraft 102 (or other vehicle in an EW environment) is operational through an environment 100 that contains multiple emitters 104. Each emitter 104 may be, for example, an enemy emitter or a friendly or neutral emitter (such as a base station operated by a carrier). Each emitter 104 may emit one or more signals 106 that are received at one or more antennas (or antenna arrays) 102b of the aircraft 102. Each of the signals 106 may have different characteristics, such as center frequency, amplitude, modulation category, or pulse width. One or more processors (or processing circuitry) 102a in the aircraft 102 may determine whether or not to take countermeasures 108 in response to reception of one or more of the signals 106 from one or more of the emitters 104. The countermeasures 108 may include, for example, electronic countermeasures such as emitting jamming signals or countering signals or taking physical action such as engaging in evasive maneuvers.

The aircraft 102 has an onboard processor 102a to detect the signals 106 received by the antennas 102b. The processor 102a performs high-speed signal analysis and threat evaluation. The processor 102a may include, for example, a general-purpose processor, a central processor unit (CPU), an Advanced Reduced Instruction Set Computer (RISC) Machine (ARM), Digital Signal Processor (DSP), Field-Programmable Gate Array (FPGA), and/or Application-Specific Integrated Circuit (ASIC) among others. The processor(s) 102a may in combination handle a wide range of tasks and support a variety of software applications for signal analysis and response management, interact with other aircraft systems and for manage user interfaces within the aircraft 102, process signal data at high speeds (including transforming and analyzing the data), and configure processing operations to adapt to new threats or changes in the signal environment, among others.

The signals 106 originate from various emitters 104. The emitters may include hostile radar installations, electronic countermeasure systems, or communication signal transmitters, each capable of emitting complex modulated signals across a wide range of frequencies and power levels. The signals may employ techniques such as frequency hopping or phase modulation to evade detection and jamming, posing a significant challenge for electronic warfare systems. The signals 106 may include radar signals and communication signals, among others. Radar Signals are typically high-frequency pulses used for detection and ranging and may vary in pulse width, repetition frequency, and modulation techniques. Radar systems may use pulse compression techniques or frequency hopping to avoid jamming and detection. Communication signals may be emitted by base stations, for example, and used by consumer or business/industrial devices.

The processor 102a in the aircraft 102 may use DSP techniques to analyze the signals 106. In general, the processor 102a may demodulate and decode the signals 106 to extract parameters such as frequency, phase, amplitude, and modulation type. The parameters may be analyzed by the processor 102a to classify the type of emitter 104 that has emitted each signal 106 and assess the potential threat the emitter 104 poses. The processor 102a may control emitters in the aircraft 102 to transmit electronic countermeasure signals in response to the analysis. The electronic countermeasure signals may be specifically designed to disrupt or deceive electronic systems and thus may include noise jamming signals, which are broad-spectrum emissions intended to mask various aircraft signals and interfere with the enemy's signal reception, or other jamming techniques like replicating or altering signals to confuse radar or communication systems (e.g., to suggest a different location or velocity of the aircraft 102) or electronic spoofing and deception techniques to mimic the characteristics of friendly or neutral entities to mislead enemy sensors.

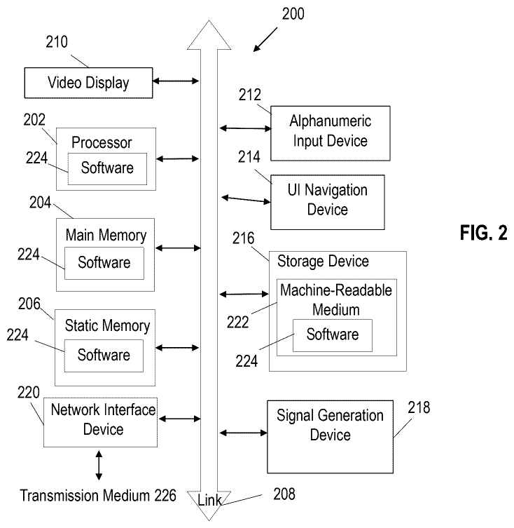

FIG. 2 illustrates a block diagram of an electronic device in accordance with some aspects. The electronic device 200 may be a specialized computer, dedicated equipment, or any machine in an EW vehicle (such as an aircraft) capable of executing instructions (sequential or otherwise) that specify actions to be taken by that machine in an EW environment. Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The electronic device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The electronic device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The electronic device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The electronic device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The non-transitory machine readable medium 222 is a tangible medium. The instructions 224 may also reside, completely or at least partially, within the main memory 204, within static memory 206, and/or within the hardware processor 202 during execution thereof by the electronic device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the electronic device 200 and that cause the electronic device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), IEEE 202.11 family of standards, and wireless data networks. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single-or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a GSM radio communication technology, a GPRS radio communication technology, an Enhanced Data Rates for GSM Evolution (EDGE) radio communication technology, and/or a Third Generation Partnership Project (3GPP) radio communication technology.

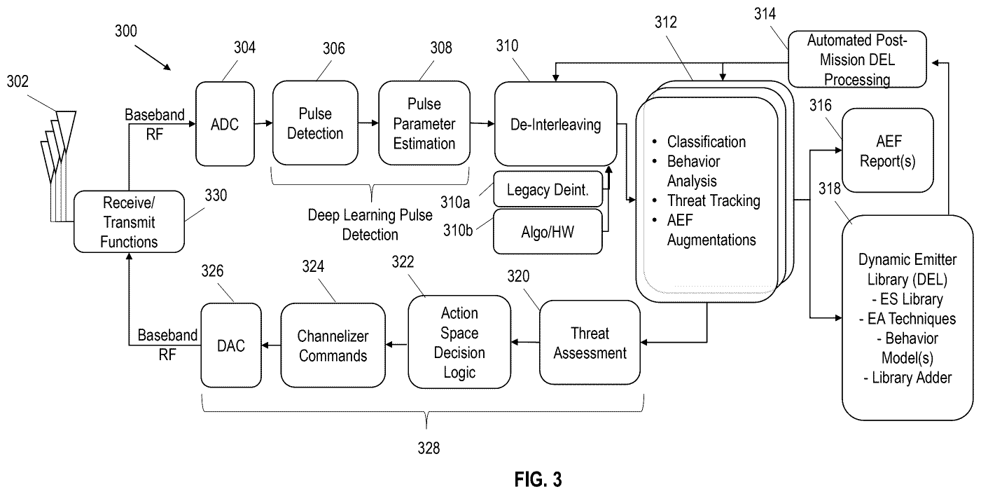

FIG. 3 illustrates an electronic warfare system according to some embodiments. The electronic warfare system 300 may be installed in the aircraft shown in FIG. 1. The electronic warfare system 300 includes one or more antennas 302 (or antenna arrays) that are configured to receive signals (i.e., waveforms) having a wide range of characteristics and from at least about a 180-degree range of reception (towards the ground). The signals are thus captured by a single or multiple set of antennas 302 at a center frequency, Fc.

Signals received by the antennas 302 may be supplied to receive/transmit circuitry 330 that provides receive/transmit functions. The receive/transmit circuitry 330 may include, for example, an RF front end that includes a circulator that permits transfer of the received signals from the antennas 302 to a receive chain of the electronic warfare system 300 or electronic countermeasure signals from a transmit chain of the electronic warfare system 300 to the antennas 302 for transmission of the electronic countermeasure signals. The receive/transmit circuitry 330 may also include one or more of amplifiers, filters, mixers, and buffers, for example. The mixers, for example, may be used to downconvert the received signals to baseband radio frequency (RF) signals, which are filtered by one or more filters to remove interference.

The analog baseband RF signals may be supplied to an analog-to-digital converter (ADC) 304. The digital signals created by the ADC 304 may be supplied to a pulse detector 306 and pulse parameter estimator 308 that estimates various parameters of the pulses from the ADC 304. The ADC 304, pulse detector 306, and pulse parameter estimator 308 may digitize the analog baseband RF signals into PDW that summarize the waveform parameters in the detected pulse. In some embodiments, a ML model may be used by the pulse detector 306 and pulse parameter estimator 308 to provide deep learning pulse detection.

In some embodiments, the pulse detector 306 may include a digital sampling circuit that converts the analog baseband RF signals to digital samples. These samples may be referred to as IQ samples since the samples can be represented as a complex number with real (I) and imaginary (Q) components. The pulse detector 306 determines which IQ samples belong to a pulse and which belong to periods of noise without pulses. In radar applications, radar signals may have large duty cycles in which pulses are only present for a fraction of the transmission time. Therefore, only retaining IQ samples from times in which pulses are present allows a reduction of samples to be processed. The pulse parameter estimator 308 may similarly be used to further reduce the representation of a pulsed waveform to a smaller number of parameters that describe the pulse as PDWs.

In particular, the environments in which the electronic warfare system 300 is used may have a number of active emitters that generate a high density of pulsed waveforms (i.e., pulses, or radar signals). As above, processing all of the pulses so generated using a power-limited embedded processor may be difficult at best. Accordingly, PDWs are used to describe the received pulses. A PDW is essentially a compact, downsampled representation of various characteristics of radar pulses. These characteristics include parameters such as pulse width, pulse repetition interval (PRI), pulse amplitude, angle of arrival, center frequency, and others depending on the specific receiver.

The output from the pulse parameter estimator 308 may be supplied to a de-interleaving module 310. The de-interleaving module 310 may include a legacy de-interleaving module 310a and a deep-learning algorithm or hardware 310b to provide de-interleaving of the PDWs. The de-interleaving module 310 may process the PDWs to infer which PDWs are emitted from the same emitter shown in FIG. 1. Such inference may utilize different sensors and measurements, as described in more detail below.

The output of the de-interleaving module 310 may be supplied to a multi-mode module 312 that provides a number of different functions based on the de-interleaved PDWs. The functions may include, for example, classification, behavioral analysis, threat tracking, and Active Emitter File (AEF) augmentation. Classification may be used to infer the type and identity of a threat with different granularities (e.g., Target Engagement Radar, Threat Type A, Foe, Serial Number 123, . . . ). Behavioral analysis may be used to infer the operating mode of the radar and quantify any significant and/or unexpected changes in the waveform. AEF Augmentations may be used to supply downstream algorithms with new and useful information to enact Electronic Countermeasures (ECM) and supply other ML algorithms.

The output of the multi-mode module 312 is used to create an AEF report 316 and store the information from the multi-mode module 312 in a Dynamic Emitter Library (DEL) 318 onboard the aircraft. The DEL 318 may contain an electronic support(ES) library, electronic attack (EA) techniques, behavior model(s) of signals, and a library adder. Unlike an MDF, which is a database with rows of data such as Radar-A, Frequency A, PW-A, Modulation-A, the DEL 318 is a library of PDWs from different emitters used to train the ML algorithm to build a structure to determine to which class a received pulse belongs. The DEL 318 may include useful ML features and behavioral patterns that are added at inference time of the ML model. The information in the DEL 318 may be supplied to an automated emitter library update 314, which may provide automated processing to, among others, associate new emitter data with an existing emitter label, permitting re-training/updating of ML algorithms to incorporate the information so that subsequent observations of the same pattern permit correct classification. This avoids the use of a traditional MDF (or similar table) in the architecture described herein. Moreover, as the classifiers are used for training are lightweight compared to deep learning networks that use a large computer with GPUs for training, the library updates may occur during a mission. This also avoids complicated issues associated with adding new signals to the supervised library, as this process simply involves a fine tuning of supervised ML algorithms without manual parameter tuning. The output of the automated emitter library update 314 may be supplied to the multi-mode module 312 for subsequent use. The automated emitter library update 314 may be used to extract useful information in the DEL 318 to update various ML model logic. The automated emitter library update 314 may provide automated post-mission DEL processing in some embodiments.

The output of the multi-mode module 312 may also be used by a countermeasure module 328 to determine ECM priority and generate countermeasure waveform for transmission via the transmit chain. The countermeasure module 328 may include a threat assessment module 320 that determines from the multi-mode module 312 information the level of threat from the received signals, action space decision logic 322 that determines the appropriate action to take based on the threat assessment (e.g., jamming, evasion, nothing), a channelizer commands module 324 that creates the appropriate digital signals based on instructions from the action space decision logic 322, and a digital-to-analog converter (DAC) 326 that converts the PDWs from the channelizer commands module 324 to response baseband RF signals. The response baseband RF signals are supplied to the receive/transmit circuitry 330 for transmission by the antennas 302.

As above, data analysis and augmentation leading to deployment of logical adjustments in EW algorithms are often performed post-sortie and use significant human interaction and judgment. An automated and data driven process is described herein to manage large amounts of data compiled by the ML algorithm and stored in the D-MDF while also extracting as much useful information possible quickly. The latency between data collection by the DEL during a mission to information extraction during or after the mission and compiled embedded software with update logic can be driven down to a multi-hour (or less) time scale without any significant human interaction, which may aid in developing a continuously evolving airborne platform. After the update, the new DEL may be used in the manner described herein to accurately produce an for use of an Active Emitter File (AEF) using its adjusted logic to better determine and generate an Electronic Attack (EA) countermeasures for transmission by the aircraft in the EW environment.

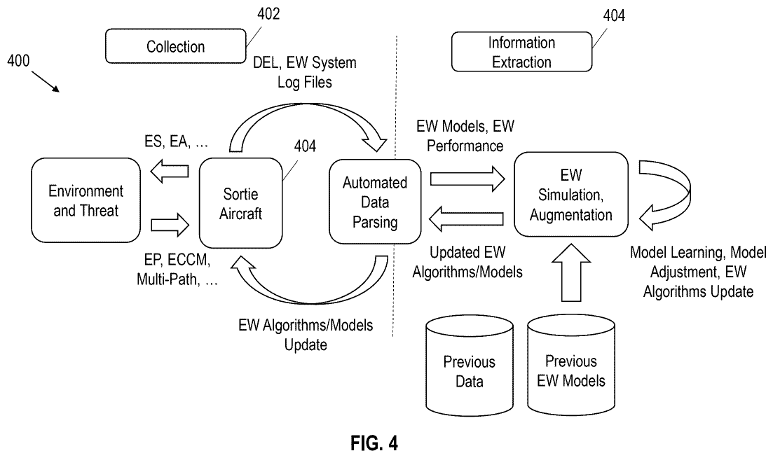

FIG. 4 illustrates a DEL information pipeline according to some embodiments. The overall process 400 shown in FIG. 4 includes a DEL collection process 402 and a DEL collection process 404. The DEL collection process 402 includes a vehicle (e.g., aircraft) engaging in a sortie in an EW environment. The aircraft uses the DEL to determine threats in the EW environment as well as in the determination of which countermeasures to take in response to the threats. The aircraft uses Electronic Support(ES) to recognize the threats by detecting, classifying, recording, identifying, and locating RF emitters of surveillance and communication links of hostile (military) systems. ES systems are passive equipment and do not radiate during operation. EA is applied against weapon and radar systems as well as wireless communications. EA uses Electro Magnetic (EM) energy, direct energy, or anti-radiation weapons to attack personnel, structures or equipment to degrade, neutralize, or destroy enemy combat capabilities. The EA may be performed with active (radiating) or passive (non-radiating or re-radiating) equipment. Electronic protection (EP) reduces or eliminates the effects of an electronic attack on friendly sensors and may include Electronic Support Measures (ESM), Electronic Counter Measures (ECM), and Electronic Counter Counter Measures (ECCM).

The aircraft provides the DEL and EW system log files to an EW processor to undertake automated data parsing. The EW processor may be in the aircraft or may be located off the aircraft at a home base to which the aircraft returns after the mission. The EW processor updates the EW algorithm and models and transmits the updated EW algorithm and models to the processor in the aircraft. During DEL information extraction the current EW models (i.e., unsupervised and supervised ML models) and performance of the EW models may be provided to the EW processor. The EW processor may extract the information from the D-MDF and conduct additional simulations of the EW environment. The results of the simulations may be used to augment the EW models through model learning and adjustment, which may result in updating the algorithms. In other words, each ML model is similar to a function f (x) and provides an output (y) based on a specific input (x); the augmentation drives the adjustment the function f ( ) provided by the ML model.

The simulations may use previous EW models stored in a database, as well as previous DEL data. This allows processing the DEL and/or other mission data to quickly extract critical EW behaviors and re-train the ML models, potentially during the mission. The DEL is collected during the mission and the feedback shown may enable a continuous learning process. While the DEL is used in FIG. 3 to adjust feature generation, the information extraction allows for model retraining as described in FIGS. 4 et seq. In other words, as opposed to adjusting the input to the ML model, the model itself is adjusted.

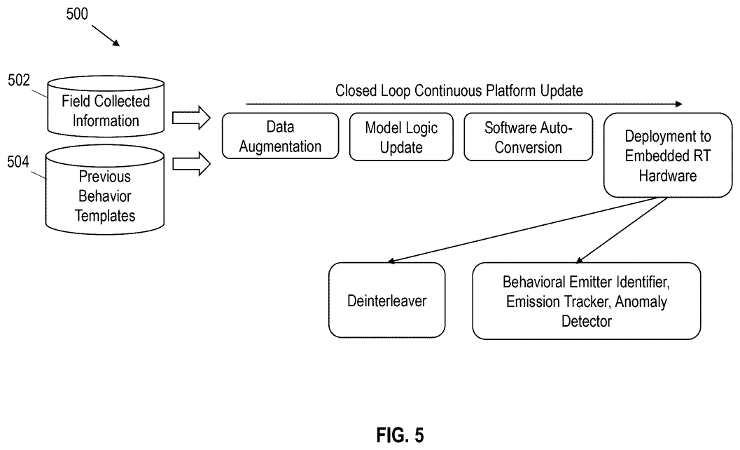

FIG. 5 illustrates a continuous learning diagram according to some embodiments. The diagram 500 includes a closed loop continuous platform update process the DEL 502 used to collect data in the field (EW environment) and one or more templates 504 of previous behavior in the EW environment. In particular, the DEL 502 may be augmented during the mission based on data collected from electronic signals during EW missions using the EW models. The DEL 502 and templates 504 are first provided to a data augmentation algorithm for augmentation of one or more of the EW models used in subsequent augmentation of the DEL 502.

Data augmentation may be used during the DDEL post-mission processing. The DDEL 502 may contain behaviors that are new but may not have exhaustively exposed every possible threat behavior. The data augmentation applies modifications to recorded interactions to make additional plausible interactions for training data of one or more of the ML models. This process is automated to supply training, testing, and validation data to perform re-training of the ML models used in FIG. 3.

In particular, the data augmentation by a data augmenter incorporates both the DEL information as well as existing behavior templates in the EW environment. Each behavior template describes the behavior for a different known emitter in the EW environment, such as frequency hopping (or adjustment of the range of frequency hopping), use of a new frequency/channel, change in modulation, use of one or more different pulse widths, etc.

To augment the ML model, the newly observed behavior of each emitter is added to the existing template for that emitter and a new template is added for a newly observed emitter in the EW environment based on the DEL information. The templates are non-lienarly modified, then superimposed to train each ML model. The augmentation may be non-linear and may be selected and applied randomly by the data augmenter. This may be like a Monte Carlo approach and is used to create a diverse set of plausible interactions based on the limited data obtained during a mission to provide a quantifiable configuration of functionality (e.g., frequency hopping).

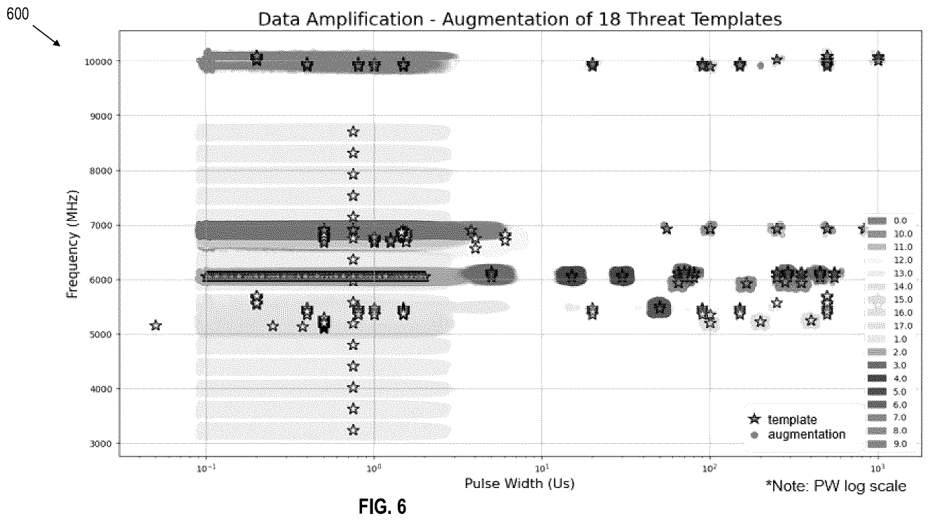

FIG. 6 illustrates data augmentation in (Frequency, Pulse Width) space according to some embodiments. The graph 600 of FIG. 6 shows example augmentations in the (frequency, pulse width) space for simplicity, but augmentations may be applied in any number of dimensions, including time. Threat templates for each emitter are represented by different numbers. The templates may be from field-collected data or from simulation. In some embodiments, the DEL data may always be used, while in other embodiments, data from other sources (such as other simulations) may be ingested into the augmenter. The individual stars represent observed behavior from each emitter during the mission(s). The augmentations to the templates are shown by the bands surrounding the stars.

After the templates have been augmented to create many plausible interactions, the templates may be used by gradient descent optimization algorithm to retrain the ML models to provide updated ML logic and thus enhanced outputs during the next mission. The updated ML models may be automatically converted from the software used to train the ML models to software that is embedded in the aircraft hardware used for the mission. For example, the ML models may be trained in Python and automatically converted to C/C++, and cross-compiled for the target platform. Note that other embodiments may use other software packages to achieve the same goal. The toolchain here is a means to create a continuously evolving air-platform. The ML model updates may be used in both the deinterleaver and the behavioral emitter identifier, emission tracker, and anomaly detector.

The information may be used to train several types of ML models. The ML models may include, but are not limited to, neural networks, decision trees, and ensemble methods like Random Forests or Gradient Boosting Machines. The choice of model typically depends on the specific characteristics of the data being acted on (i.e., the stage of the system shown in FIG. 3), and the operational requirements of the EW system, such as speed of execution and accuracy. The training process involves adjusting the weights and parameters of the models to minimize error in signal classification and threat identification.

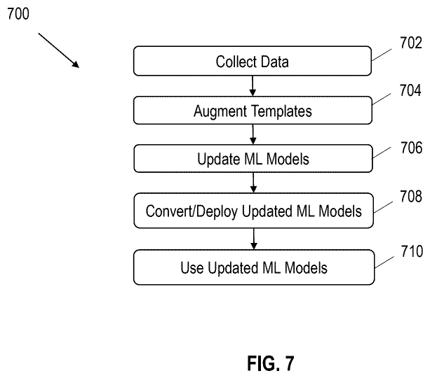

FIG. 7 illustrates a method of updating a machine learning model in accordance with some aspects. In some embodiments, the electronic device(s), network(s), system(s), chip(s) or component(s), or portions or implementations thereof may be configured to perform one or more processes, techniques, or methods as described herein, or portions thereof. Only some of the operations are shown in the process 700 of FIG. 7; other operations may be present but are not shown.

At operation 702, data is collected from an EW environment during a mission. Multiple ML models may be used to collect the data, which is stored in a DEL. For example, one or more unsupervised ML models may be used by a deinterleaver to separate signals received simultaneously during a dwell into waveforms from different emitters. Subsequently, one or more supervised ML models may be used to identify the emitters, as well as perform waveform tracking and emitter anomaly detection based on the deinterleaved waveforms. The data stored in the DEL may be altered from waveforms emitted by the emitters due to superimposing and/or environmental effects such as geometry, multi-path, pulse on pulse, etc.

At operation 704, after the mission, the DEL may be used to augment existing templates that describe the emitters in the EW environment. That is, the new data collected during the last mission may be used to update the behavior (functionality) of each of the emitters.

At operation 706, the templates may be used to train the ML models for more accuracy. As limited data sets may be available for each emitter, interactions between the emitters in the EW environment may be simulated to train the ML models to recognize specific emitters and characteristics in the EW environment. That is, as each emitter may have multiple feature vectors that each describe different waveforms that may be emitted, a potentially huge number of overlapping waveforms may be possible in the EW environment. To limit the amount of processing used to update the ML models, a Monte Carlo (or other random) approach is taken in which random sets of known emitters and waveforms emitted by the known emitters are combined to result in a computationally reasonable manner to update the ML models. That is, a Monte Carlo algorithm may be used for EW data augmentation based on randomized non-linear superposition of behavioral transforms to create large numbers of plausible EW interactions (i.e., combinations of emitter waveforms received in the EW environment within a dwell). The ML models may be trained to account for the behavior of the emitters to include the superimposing and/or environmental effects. The superimposing and/or environmental effects may alter extrinsic emitter features, such as Pulse Amplitude (PA), Time of Arrival (TOA), and/or Angle of Arrival (AOA) without affecting intrinsic emitter features, such as Carrier Frequency (Fc), Pulse Width (PW), pulse repetition interval (PRI), modulation type, and signal bandwidth (BW). This permits the ML models to determine the effects of the waveform interactions on the actual waveforms emitted by the emitters in the EW environment.

At operation 708, after training, the ML models are automatically converted from the software used to train the system to software deployed in embedded processor in the aircraft. The ML models are then deployed to the processor and other firmware in the aircraft.

At operation 710, during the next mission, the updated ML models are used to identify emitters in the EW environment based on the waveforms received during the next mission, and to generate appropriate countermeasures to the emitters.

### EXAMPLES

Example 1 is a system for updating Machine Learning (ML) models used in an electronic warfare (EW) environment, the system comprising: processing circuitry configured to: obtain, from a Dynamic Emitter Library (DEL), threat data of emitters in the EW environment during a mission using ML models; automatically update the ML models post mission using the DEL to form updated ML models; and deploy the updated ML models to hardware, the updated ML models in the hardware used during a subsequent mission to deinterleave waveforms received from the emitters in the EW environment and for emitter identification, waveform tracking, and emitter anomaly detection based on the deinterleaved waveforms; and a memory configured to store the DEL.

In Example 2, the subject matter of Example 1 includes, wherein the ML models include an unsupervised ML model to deinterleave the waveforms and a supervised ML model for emitter identification, waveform tracking, and emitter anomaly detection.

In Example 3, the subject matter of Examples 1-2 includes, wherein to update the ML models, the processing circuitry is configured to augment templates that indicate behavior of the emitters using the threat data in the DEL to create augmented templates and train the ML models using the augmented templates, the behavior of the emitters including frequency hopping, frequency use, and modulation.

In Example 4, the subject matter of Example 3 includes, wherein: the threat data in the D-MDF includes threat data of emitters in the EW environment but not in the templates, and to update the ML models, the processing circuitry is configured to use the threat data in the DEL to create new templates that include behavior of the emitters in the EW environment but not in the threat templates and train the ML models using the new templates.

In Example 5, the subject matter of Example 4 includes, wherein to update the ML models, the processing circuitry is configured to select and apply non-linear augmentations of at least one of the augmented templates and new templates randomly.

In Example 6, the subject matter of Example 5 includes, wherein to update the ML models, the processing circuitry is configured to use a Monte Carlo approach to select and apply the non-linear augmentations.

In Example 7, the subject matter of Example 6 includes, wherein: the threat data stored in the D-MDF includes altered waveforms from waveforms that have been emitted by the emitters and altered by at least one of superimposing and environmental effects, and to update the ML models, the processing circuitry is configured to train the ML models to account for the at least one of the superimposing and environmental effects.

In Example 8, the subject matter of Example 7 includes, wherein the at least one of the superimposing and environmental effects alter extrinsic emitter features, which include Pulse Amplitude (PA), Time of Arrival (TOA), and Angle of Arrival (AOA) without affecting intrinsic emitter features, which include Carrier Frequency (Fc), Pulse Width (PW), pulse repetition interval (PRI), modulation type, and signal bandwidth (BW).

In Example 9, the subject matter of Examples 3-8 includes, wherein the processing circuitry is configured to update the ML models using data from additional sources other than the DEL.

Example 10 is a method of updating ML models used in an EW environment, the method comprising: obtaining threat data of emitters in an EWenvironment using ML models; automatically updating the ML models post mission using the threat data to form updated ML models; and deploying the updated ML models to hardware, the updated ML models in the hardware used during a subsequent mission include, an unsupervised ML model to deinterleave waveforms received from the emitters in the EW environment to form deinterleaved waveforms and a supervised ML model for emitter identification, waveform tracking, and emitter anomaly detection based on the deinterleaved waveforms.

In Example 11, the subject matter of Example 10 includes, updating the ML models by augmenting templates that indicate behavior of the emitters using the threat data to create augmented templates and training the ML models using the augmented templates.

In Example 12, the subject matter of Example 11 includes, wherein: the threat data includes threat data of emitters in the EW environment but not in the templates, and further comprising updating the ML models using the threat data to create new templates that include behavior of the emitters in the EW environment but not in the threat templates and train the ML models using the new templates.

In Example 13, the subject matter of Example 12 includes, updating the ML models by selecting and applying non-linear augmentations of at least one of the augmented templates and new templates randomly using a Monte Carlo approach.

In Example 14, the subject matter of Example 13 includes, wherein the non-linear augmentations are based on the behavior of the emitters, which include extrinsic emitter features that include Pulse Amplitude (PA), Time of Arrival (TOA), and Angle of Arrival (AOA) and intrinsic emitter features that include Carrier Frequency (Fc), Pulse Width (PW), pulse repetition interval (PRI), modulation type, and signal bandwidth (BW).

In Example 15, the subject matter of Examples 10-14 includes, updating the ML models using data from a DEL stored in an aircraft used during the mission and additional sources other than the DEL.

Example 16 is a non-transitory computer-readable medium storing instructions that, when executed by a processor, cause the processor to: obtain threat data of emitters in an electronic warfare (EW) environment using Machine Learning (ML) models, the threat data of the emitters including behavior of the emitters including intrinsic emitter features and extrinsic emitter features of the emitters; automatically update the ML models post mission using the threat data to form updated ML models; and deploy the updated ML models to hardware, the updated ML models in the hardware used during a mission include, an unsupervised ML model to deinterleave waveforms received from the emitters in the EW environment to form deinterleaved waveforms and a supervised ML model for emitter identification, waveform tracking, and emitter anomaly detection based on the deinterleaved waveforms.

In Example 17, the subject matter of Example 16 includes, wherein the instructions, when executed by the processor, update the ML models by augmenting templates that indicate the behavior of the emitters using the threat data to create augmented templates and training the ML models using the augmented templates.

In Example 18, the subject matter of Example 17 includes, wherein: the threat data includes threat data of emitters in the EW environment but not in the templates, and the instructions, when executed by the processor, update the ML models by using the threat data to create new templates that include the behavior of the emitters in the EW environment but not in the threat templates and training the ML models using the new templates.

In Example 19, the subject matter of Example 18 includes, wherein the instructions, when executed by the processor, update the ML models by selecting and applying non-linear augmentations of at least one of the augmented templates and new templates randomly using a Monte Carlo approach.

In Example 20, the subject matter of Example 19 includes, wherein the instructions, when executed by the processor, update the ML models using data from a DEL stored in an aircraft used and additional sources other than the DEL.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although embodiments have been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. For example, the term “a processor” configured to carry out specific operations includes both a single processor configured to carry out all of the operations as well as multiple processors individually configured to carry out some or all of the operations (which may overlap) such that the combination of processors carry out all of the operations. Note that the term “about x” and similar terms (e.g., substantially) as used herein may be understood to be within 10% of x or otherwise within a range known to one of skill in the art to be within tolerance of the quantity or quality described unless indicated otherwise.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A system for updating Machine Learning (ML) models used in an electronic warfare (EW) environment, the system comprising:
processing circuitry configured to:
obtain, from a Dynamic Emitter Library (DEL) file, threat data of emitters in the EW environment during a mission using ML models;
automatically update the ML models post mission using the DEL to form updated ML models; and
deploy the updated ML models to hardware, the updated ML models in the hardware used during a subsequent mission to deinterleave waveforms received from the emitters in the EW environment and for emitter identification, waveform tracking, and emitter anomaly detection based on the deinterleaved waveforms; and
a memory configured to store the DEL.

2. The system of claim 1, wherein the ML models include an unsupervised ML model to deinterleave the waveforms and a supervised ML model for emitter identification, waveform tracking, and emitter anomaly detection.

3. The system of claim 1, wherein to update the ML models, the processing circuitry is configured to augment templates that indicate behavior of the emitters using the threat data in the DEL to create augmented templates and train the ML models using the augmented templates, the behavior of the emitters including frequency hopping, frequency use, and modulation.

4. The system of claim 3, wherein:
the threat data in the DEL includes threat data of emitters in the EW environment but not in the templates, and
to update the ML models, the processing circuitry is configured to use the threat data in the DEL to create new templates that include behavior of the emitters in the EW environment but not in the threat templates and train the ML models using the new templates.

5. The system of claim 4, wherein to update the ML models, the processing circuitry is configured to select and apply non-linear augmentations of at least one of the augmented templates and new templates randomly.

6. The system of claim 5, wherein to update the ML models, the processing circuitry is configured to use a Monte Carlo approach to select and apply the non-linear augmentations.

7. The system of claim 6, wherein:
the threat data stored in the DEL includes altered waveforms from waveforms that have been emitted by the emitters and altered by at least one of superimposing and environmental effects, and
to update the ML models, the processing circuitry is configured to train the ML models to account for the at least one of the superimposing and environmental effects.

8. The system of claim 7, wherein the at least one of the superimposing and environmental effects alter extrinsic emitter features, which include Pulse Amplitude (PA), Time of Arrival (TOA), and Angle of Arrival (AOA) without affecting intrinsic emitter features, which include Carrier Frequency (Fc), Pulse Width (PW), pulse repetition interval (PRI), modulation type, and signal bandwidth (BW).

9. The system of claim 3, wherein the processing circuitry is configured to update the ML models using data from additional sources other than the DEL.

10. A method of updating Machine Learning (ML) models used in an electronic warfare (EW) environment, the method comprising:
obtaining threat data of emitters in an electronic warfare (EW) environment using ML models;
automatically updating the ML models post mission using the threat data to form updated ML models; and
deploying the updated ML models to hardware, the updated ML models in the hardware used during a subsequent mission include an unsupervised ML model to deinterleave waveforms received from the emitters in the EW environment to form deinterleaved waveforms and a supervised ML model for emitter identification, waveform tracking, and emitter anomaly detection based on the deinterleaved waveforms.

11. The method of claim 10, further comprising updating the ML models by augmenting templates that indicate behavior of the emitters using the threat data to create augmented templates and training the ML models using the augmented templates.

12. The method of claim 11, wherein:
the threat data includes threat data of emitters in the EW environment but not in the templates, and
further comprising updating the ML models using the threat data to create new templates that include behavior of the emitters in the EW environment but not in the threat templates and train the ML models using the new templates.

13. The method of claim 12, further comprising updating the ML models by selecting and applying non-linear augmentations of at least one of the augmented templates and new templates randomly using a Monte Carlo approach.

14. The method of claim 13, wherein the non-linear augmentations are based on the behavior of the emitters, which include extrinsic emitter features that include Pulse Amplitude (PA), Time of Arrival (TOA), and Angle of Arrival (AOA) and intrinsic emitter features that include Carrier Frequency (Fc), Pulse Width (PW), pulse repetition interval (PRI), modulation type, and signal bandwidth (BW).

15. The method of claim 10, further comprising updating the ML models using data from a DEL stored in an aircraft used during the mission and additional sources other than the DEL.

16. A non-transitory computer-readable medium storing instructions that, when executed by a processor, cause the processor to:
obtain threat data of emitters in an electronic warfare (EW) environment using Machine Learning (ML) models, the threat data of the emitters including behavior of the emitters including intrinsic emitter features and extrinsic emitter features of the emitters;
automatically update the ML models post mission using the threat data to form updated ML models; and
deploy the updated ML models to hardware, the updated ML models in the hardware used during a mission include an unsupervised ML model to deinterleave waveforms received from the emitters in the EW environment to form deinterleaved waveforms and a supervised ML model for emitter identification, waveform tracking, and emitter anomaly detection based on the deinterleaved waveforms.

17. The non-transitory computer-readable medium of claim 16, wherein the instructions, when executed by the processor, update the ML models by augmenting templates that indicate the behavior of the emitters using the threat data to create augmented templates and training the ML models using the augmented templates.

18. The non-transitory computer-readable medium of claim 17, wherein:
the threat data includes threat data of emitters in the EW environment but not in the templates, and
the instructions, when executed by the processor, update the ML models by using the threat data to create new templates that include the behavior of the emitters in the EW environment but not in the threat templates and training the ML models using the new templates.

19. The non-transitory computer-readable medium of claim 18, wherein the instructions, when executed by the processor, update the ML models by selecting and applying non-linear augmentations of at least one of the augmented templates and new templates randomly using a Monte Carlo approach.

20. The non-transitory computer-readable medium of claim 19, wherein the instructions, when executed by the processor, update the ML models using data from a Dynamic Emitter Library (DEL) stored in an aircraft used and additional sources other than the DEL.
